(19) United States
(12) Patent Application Publication
(10) Pub. No.: US 2008/0016062 A1
(43) Pub. Date: Jan. 17, 2008

(54) Request-response trigger generation in link-connected computing systems

(76) Inventor: Keith A. Drescher, Olympia, WA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/479,385

(22) Filed: Jun. 30, 2006

(51) Int. Cl. G06F 17/30

(52) U.S. Cl. 707/6

(57) ABSTRACT

A method is described that involves generating a trigger signal for a transaction. The trigger is generated if the transaction matches a response and request pattern.

### FIELD OF INVENTION

The field of invention relates to the computer sciences, generally, and, more specifically, to validation and debugging of computer system components in a link-connected system.

### BACKGROUND

The validation and debug of computer system components requires the ability to capture information exchanged between agents in the system being validated and/or debugged. Logic analyzers are typically used for capturing this exchanged information of a computing system. As logic analyzers have finite capabilities in both storage and capture speed, it is necessary to set “triggers” to indicate when a logic analyzer should begin capturing data that is being exchanged. A exemplary trigger is one that indicates to a logic analyzer to capture exchanged information in response to a read at a particular address. Triggers may also take into account multiple phases of an information exchange (such as request, snoop, response, and data).

In a traditional computing system that utilizes a front-side bus (FSB) between its processor(s) and memory controller, all parts of a transaction or exchange are visible to a single logic analyzer.

In recent years computing system designers have begun to embrace the notion of replacing the FSB with a network of point-to-point links/interconnects. Traffic in a link-based system may be distributed over multiple links. The presence of the network permits simultaneous data/instruction exchanges between different pairs of communicating components that are coupled to the network. For example, a first processor and memory controller could be involved in a data/instruction transfer during the same time period in which a second processor and third processor are involved in a data/instruction transfer. Computing systems that embrace a network in lieu of a front-side bus may extend the network to include other regions of the computing system such as one or more point-to-point links between the memory controller and any of the computing system's I/O devices (e.g., network interface, hard-disk file, etc.).

The traditional approach of using a single logic analyzer does not work with link-based systems as no single observation entity is able to “see” all of the traffic of the system or even all of the parts of a single transaction because of the distributed nature of the links of the system. In some cases, even the request and response paths of a single link cannot be observed by a single logic analyzer. In multiple processor systems, responses may take multiple paths to reach the requester which means that multiple locations have to be observed to “see” the entire response. Additionally, point-to-point links (from agent to agent) are generally faster than traditional FSBs. Because of this speed, it is likely that by the time an agent is alerted to look for a transaction that the transaction will have already occurred.

Typically, requests in a point-to-point link based system carry information that determines the kind of request that is being made. For example, a request may utilize a header that includes an address, request type, attributes, etc. The relationship between a particular request and response is identified in a temporal tag (or transaction ID). Requests carry information and the tag, whereas responses only carry the tag. An external agent identifies all cases where a transaction may be completed. If a tag is reused, it is possible that a false trigger could be created.

### BRIEF DESCRIPTION OF THE DRAWINGS

The present invention is illustrated by way of example and not limitation in the figures of the accompanying drawings, in which like references indicate similar elements and in which:

FIG. 1 shows a more detailed depiction of a multi-processor computing system that uses a network between components within the computing system;

FIGS. 2(a) and 2(b) illustrates a portion of an embodiment of an exemplary agent to process an incoming request;

FIG. 3 are embodiments of flows for processing transactions incoming to an agent;

FIGS. 4(a) and 4(b) illustrates a portion of an embodiment of an exemplary agent to process an outgoing response;

FIG. 5 illustrates an exemplary embodiment of a flow for generating a trigger in response to an outgoing response from an agent;

FIG. 6 illustrates a front-side-bus (FSB) computer system in which one embodiment of the invention may be used; and

FIG. 7 illustrates a computer system that is arranged in a point-to-point (PtP) configuration.

### DETAILED DESCRIPTION

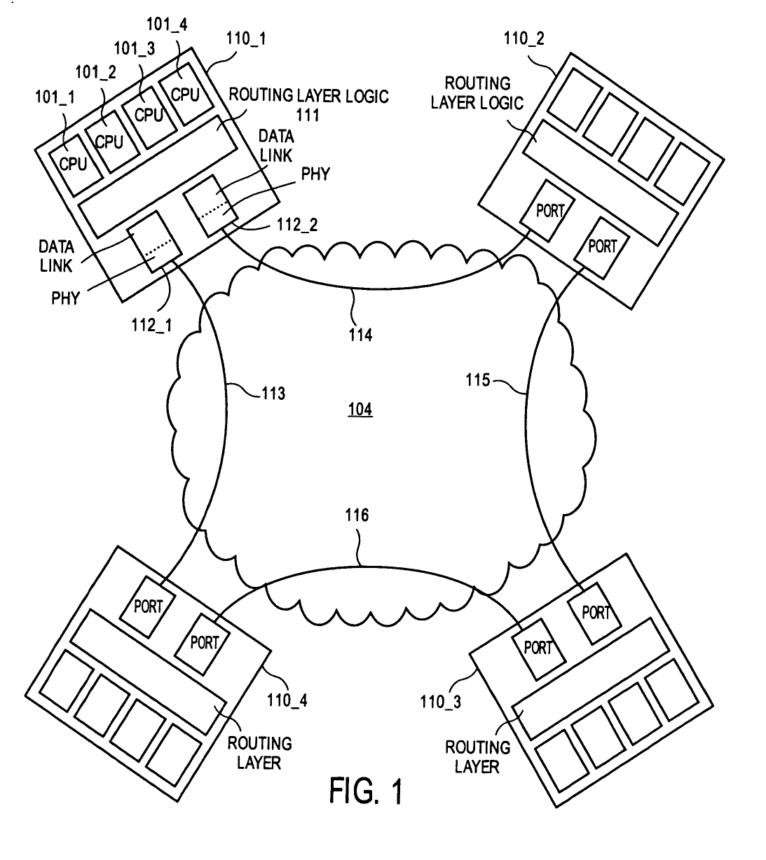

FIG. 1 shows a more detailed depiction of a multi-processor computing system that embraces the placement of a network, rather than a bus, between components within the computing system. The components 110_1 through 110_4 that are coupled to the network 104 are referred to as “sockets” because they can be viewed as being plugged into the computing system's network 104. One of these sockets, socket 110_1, is depicted in detail.

According to the depiction observed in FIG. 1, socket 110_1 is coupled to network 104 through two bi-directional point-to-point links 113, 114. In an implementation, each bi-directional point-to-point link is made from a pair of uni-directional point-to-point links that transmit information in opposite directions. For instance, bi-directional point-to-point link 114 is made of a first unidirectional point-to-point link (e.g., a copper transmission line) whose direction of information flow is from socket 110_1 to socket 110_2 and a second unidirectional point-to-point link whose direction of information flow is from socket 110_2 to socket 110_1.

Because two bi-directional links 113, 114 are coupled to socket 110_1, socket 110_1 includes two separate regions of data link layer and physical layer circuitry 112_1, 112_2. That is, circuitry region 112_1 corresponds to a region of data link layer and physical layer circuitry that services bi-directional link 113; and, circuitry region 112_2 corresponds to a region of data link layer and physical layer circuitry that services bi-directional link 114. As is understood in the art, the physical layer of a network typically forms parallel-to-serial conversion, encoding and transmission functions in the outbound direction and, reception, decoding and serial-to-parallel conversion in the inbound direction.

That data link layer of a network is typically used to ensure the integrity of information being transmitted between points over a point-to-point link (e.g., with CRC code generation on the transmit side and CRC code checking on the receive side). Data link layer circuitry typically includes logic circuitry while physical layer circuitry may include a mixture of digital and mixed-signal (and/or analog) circuitry. Note that the combination of data-link layer and physical layer circuitry may be referred to as a “port” or Media Access Control (MAC) layer. Thus circuitry region 112_1 may be referred to as a first port or MAC layer region and circuitry region 112_2 may be referred to as a second port or MAC layer circuitry region.

Socket 110_1 also includes a region of routing layer circuitry 111. The routing layer of a network is typically responsible for forwarding an inbound packet toward its proper destination amongst a plurality of possible direction choices. For example, if socket 110_2 transmits a packet along link 214 that is destined for socket 110_4, the routing layer 111 of socket 110_1 will receive the packet from port 112_2 and determine that the packet should be forwarded to port 112_1 as an outbound packet (so that it can be transmitted to socket 110_4 along link 213).

By contrast, if socket 110_2 transmits a packet along link 114 that is destined for processor 101_1 within socket 110_1, the routing layer 111 of socket 110_1 will receive the packet from port 212_2 and determine that the packet should be forwarded to processor 101_1. Typically, the routing layer undertakes some analysis of header information within an inbound packet (e.g., destination node ID, connection ID) to “look up” which direction the packet should be forwarded. Routing layer circuitry 111 is typically implemented with logic circuitry and memory circuitry (the memory circuitry being used to implement a “look up table”).

The particular socket 110_1 depicted in detail in FIG. 1 contains four processors 101_1 through 101_4. Here, the term processor, processing core and the like may be construed to mean logic circuitry designed to execute program code instructions. Each processor may be integrated on the same semiconductor chip with other processor(s) and/or other circuitry regions (e.g., the routing layer circuitry region and/or one or more port circuitry region). It should be understood that more than two ports/bi-directional links may be instantiated per socket. Also, the computing system components within a socket that are “serviced by” the socket's underlying routing and MAC layer(s) may include a component other than a processor such as a memory controller or I/O hub.

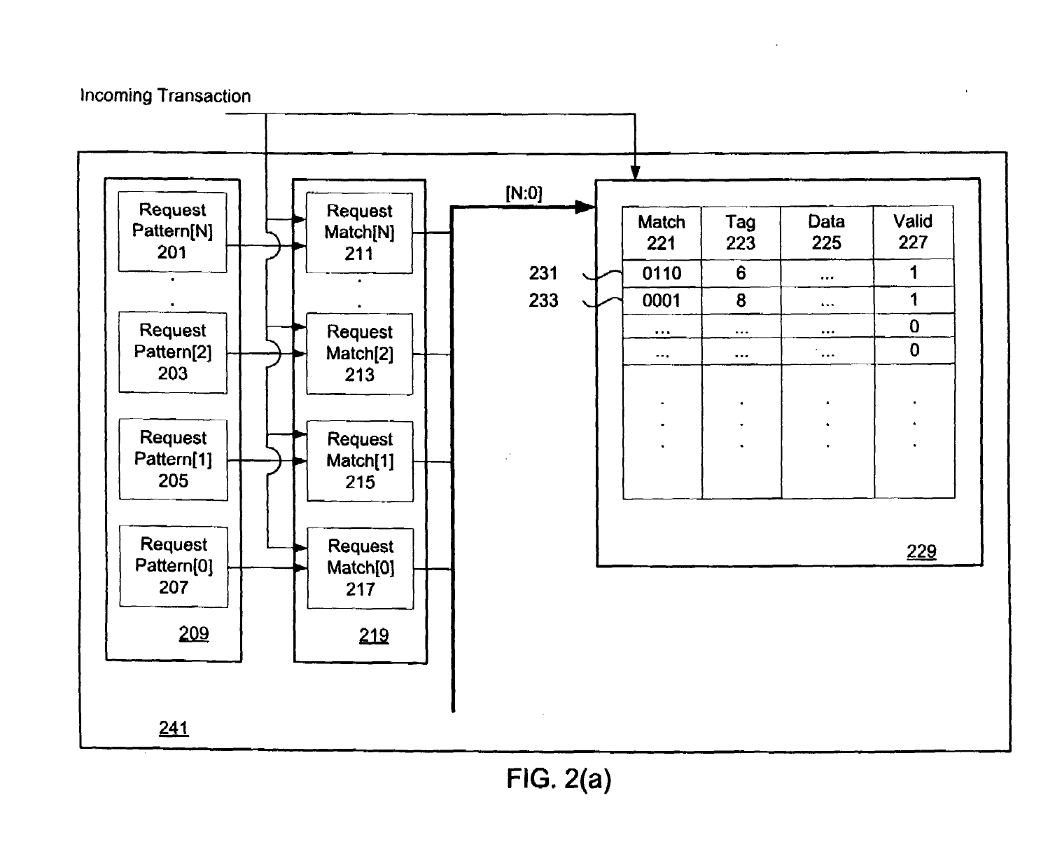

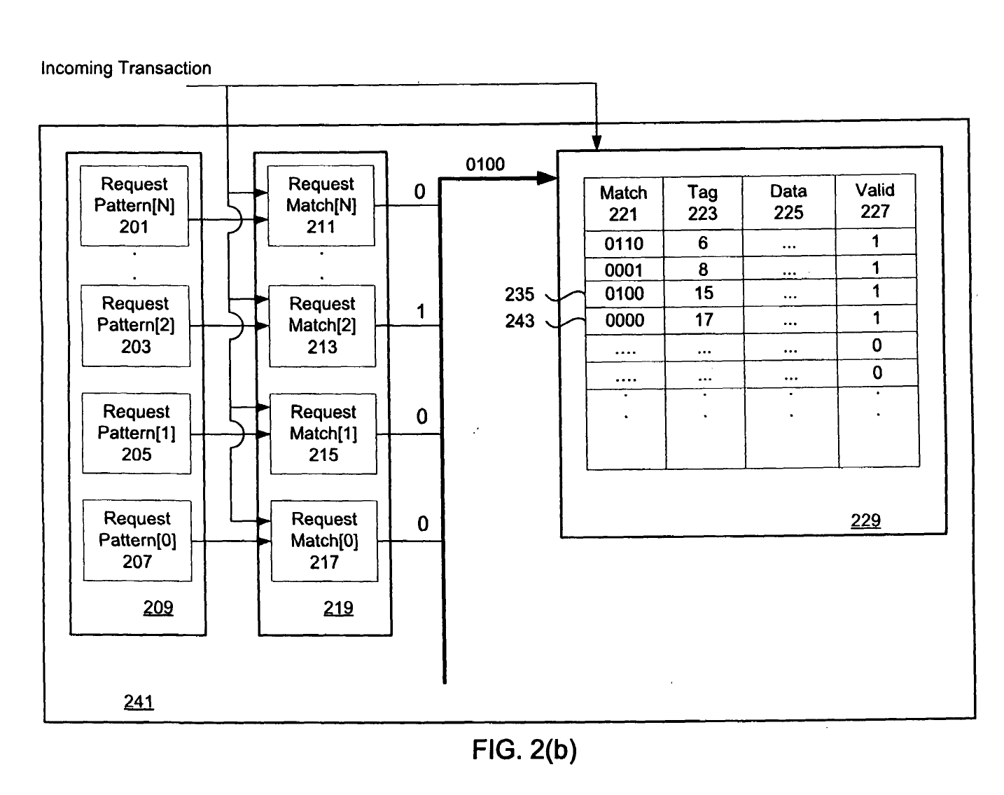

FIG. 2(a) illustrates a portion of an embodiment of an exemplary agent to process an incoming request. The agent 241 includes request pattern storage 209, request pattern matching component 219, and a transaction tracker 229.

The request pattern storage 209 stores one or more patterns which are to be matched against the header and/or data of an incoming transaction. Exemplary patterns include a complete (or portion) of a particular header's information, data (or a portion of the data) associated with the header, a combination of header information and data, etc. Header information identifies an address, request type, attribute(s), etc.

The request pattern storage 209 is typically a collection of registers with each register containing one or more patterns. As illustrated in FIG. 2(a), the request pattern storage 209 includes several different patterns 201, 203, 205, and 207 that could be matched against an incoming transaction. Of course, request pattern storage may also be a single large register containing one or more patterns, or any other storage type.

The patterns stored in the request pattern storage 209 may be stored and/or adjusted at any point during the agent's 241 lifecycle. For example, request pattern[2] 203 may be set prior to boot-up and request pattern[1] 205 may be set during runtime of the agent 241.

A request pattern matching component 219 identifies transactions coming into the agent 241 which match a request pattern from the request pattern storage 209. Masks may be used to perform this identification. Typically, there is a mask per request pattern stored, however, other mask to request pattern ratios may bed used.

Classes of related transactions may generate more than one match for the same pattern. For example, in a system where there are many “read” patterns, a transaction for the generic “read” pattern would generate more than one match, whereas a transaction for a specific “read” pattern would likely generate only one match.

The match or matches generated by the request pattern matching component 219 are marked in a transaction tracker 229. The transaction tracker 229 tracks incoming and outgoing transactions that are associated with the agent 241. An entry in the transaction tracker 229 may include information about what matches 221 were found be the matching component 219, a tag (or transaction ID) 223, other data from the transaction 225, and an valid bit indicating that the entry is already in use 227. While a table is shown in FIG. 2(a) as storing entries in the transaction tracker 229 other storage techniques such as an individual register per entry, etc. may be used. In an embodiment, entries that are not marked as valid have pre-determined values (such as all 0s) one or more of the other entry categories.

In the example shown in FIG. 2(a), there are two entries 231 and 233 that are marked as unavailable. An indication of unavailable means that a match between a transaction and request pattern was found and that the entry slot in unavailable for a new match. In this particular example, a “1” indicates that a match was found. Entry 235 does not have “1” in the unavailability column 227 and is therefore available should a subsequent match occur.

A request pattern identifier match 221 is indicated by an N-bit sized entry that is generated by the match component 219. Each bit position in the N-bit entry corresponds to a particular sub-component 211, 213, 215, 217 (such as a mask) from the match component 219 that generates a match between the incoming transaction and a particular pattern. Each request-response pair has an unique match identifier. For example, in entry 233, only sub-component 217 produced a match. By providing multiple request and response match blocks, the mechanism can trigger on one of several request-response pairs. For example, in entry 231, the match is 0110. This indicates that two sub-components of 219 produced matches. In this case, match sub-components 215 and 213 had a match. Of course, other match indicators (not illustrated) may be used.

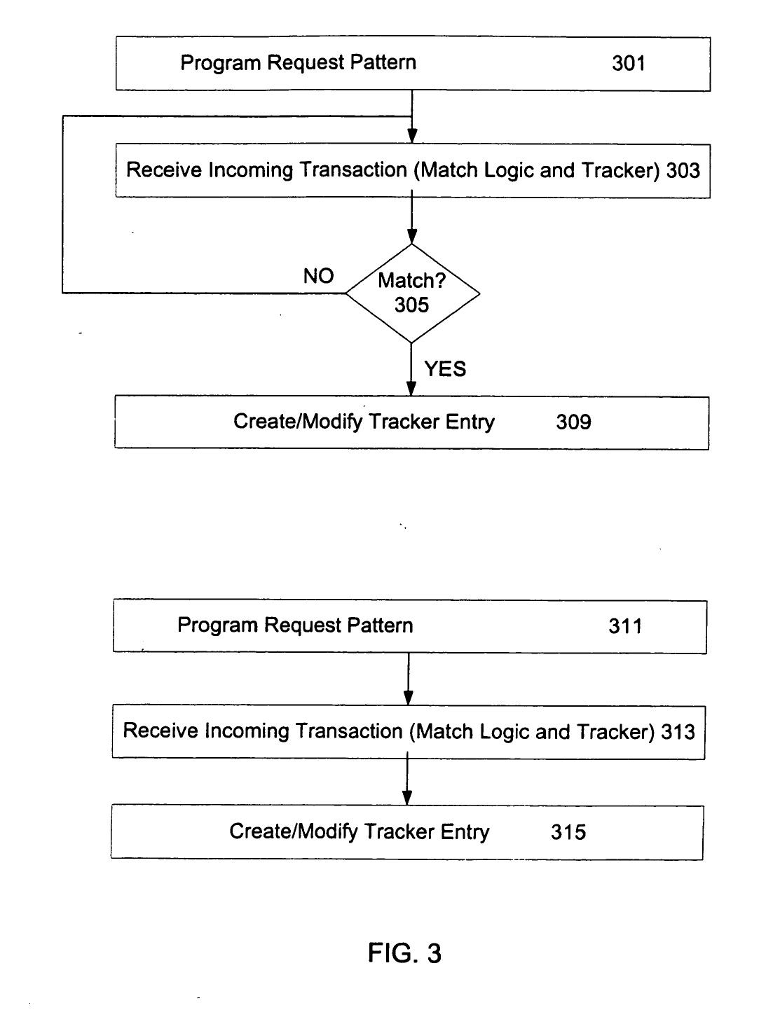

FIG. 3 are an embodiments of flows for processing transactions incoming to an agent. At 301, at least a portion of the request pattern(s) of the agent are programmed. For example, a portion of the request pattern storage 209 is programmed. As described earlier, the programming of request patterns may occur prior to boot or during operation of the agent.

An incoming transaction is received by the agent at 303. For example, a transaction is received by the match component 219. The transaction may also be received by the transaction tracker 229 at this time.

The received transaction is compared to request patterns to determine if the transaction matches at least one request pattern at 305. If none of the request patterns match the incoming transaction, the agent waits for the next transaction. If a match is found, an identifier associated with the matched request pattern(s) is generated. For example, in FIG. 2(b) request pattern[2] 203 matched the transaction and request match[2] sub-component 213 produced a positive identifier (in this case a “1”). All of the other sub-components in this example did not produce a match (no other request patterns matched).

An entry associated with a transaction that produced a match with a request pattern is created or modified at 309.

In the second flow, at 311, at least a portion of the request pattern(s) of the agent are programmed. For example, a portion the request pattern storage 209 is programmed. As described earlier, the programming of request patterns may occur prior to boot or during operation of the agent.

An incoming transaction is received by the agent at 313. For example, a transaction is received by the match component 219. The transaction may also be received by the transaction tracker 229 at this time.

At 315 an entry is created, regardless of whether or not the incoming transaction provided a match. The match bits for the entry are added to the tracker along with the other data the component needs to keep track of. For example, in an embodiment, when all the match bits are 0, then there was no incoming match for the transaction in that entry as shown in entry 243. Typically, not having a match is not seen as an error but we would not create an entry that allows trigger to be generated.

As described earlier, the creation of an entry may include storing such information as: the identifier generated by the match component, a tag associated with the transaction, data from the transaction, an available indicator, etc. In the example of FIG. 2(b), entry 235 was created within an identifier 0100 that indicates request pattern[2] 203 was matched, the tag value of 15 identifies the transaction, and a “1” for the validity indicator indicates that this slot in the tracker is being used.

Typically, the tag associated with each transaction is unique within the agent. Tags are re-used once the entry in the tracker 229 has been cleared. Tags may or may not be unique between agents. For example, two agents may have entries that use the same tag. If the system does not use globally unique tags, extra care must be taken to ensure that the correct tag generates a trigger. For example, the tag and additional identifying information such as identification of the agent that generated the tag may be used to create a very detailed tag.

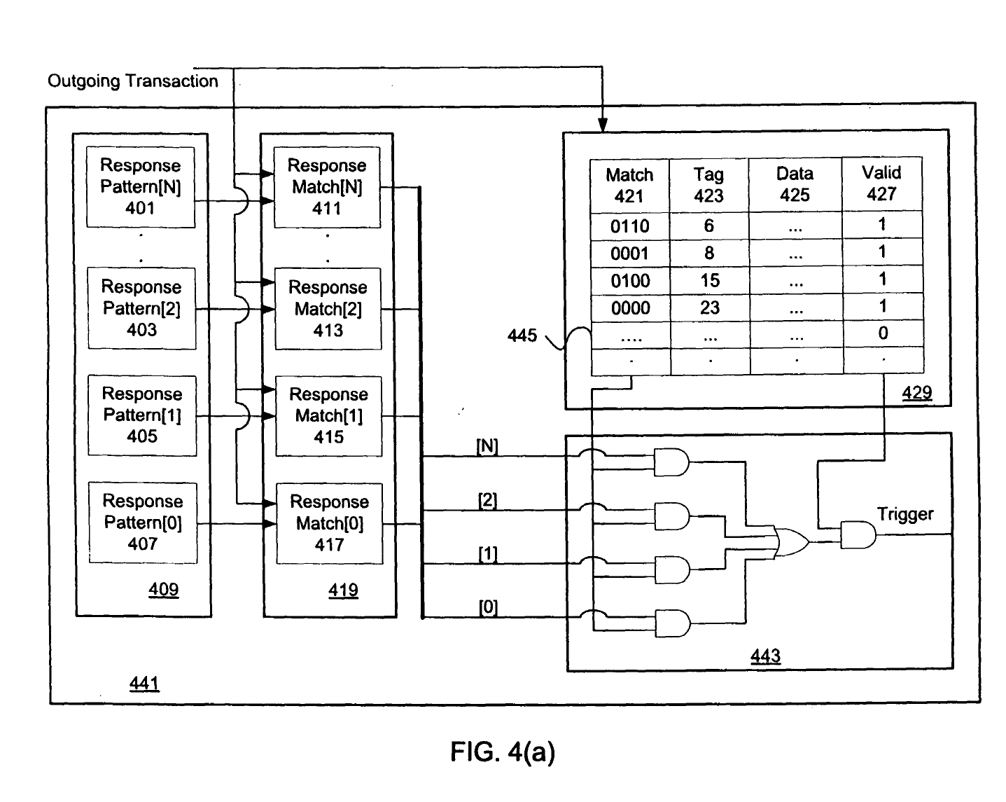

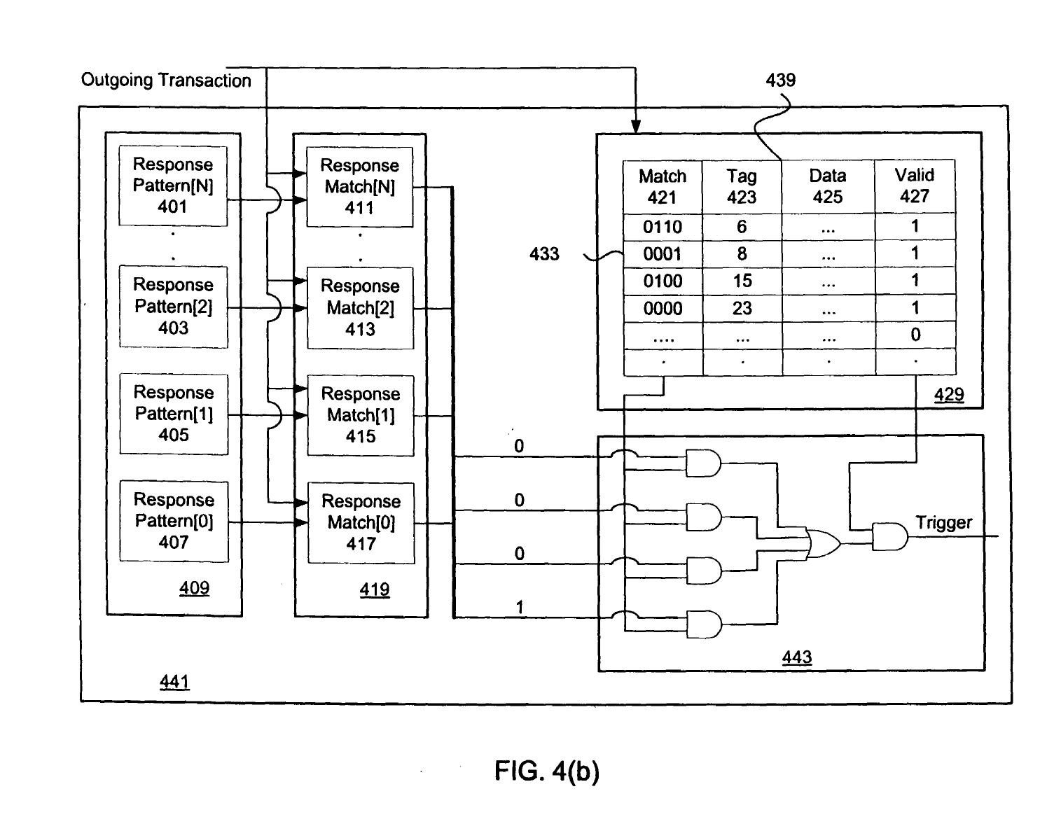

FIG. 4(a) illustrates a portion of an embodiment of an exemplary agent to process an outgoing response. The agent 441 includes response pattern storage 409, response pattern matching component 419, a transaction tracker component 429, and a trigger generation component 443.

The response pattern storage 409 stores one or more patterns which are to be matched against the header and/or data of an outgoing transaction. Exemplary patterns include a complete (or portion) of a particular header information, a data (or a portion of the data) associated with a header, a combination of header information and data, etc. Header information identifies an address, response type, attribute(s), etc.

The response pattern storage 409 is typically a collection of registers with each register containing one or more patterns. As illustrated in FIG. 4(a), the response pattern storage 409 includes several different patterns 401, 403, 405, and 407 that could be matched against an outgoing transaction. Of course, response pattern storage may also be a single large register containing one or more patterns, or any other storage type.

The patterns stored in the response pattern storage 409 may be stored and/or adjusted at any point during the agent's lifecycle. For example, response pattern[1] 405 may be set prior to boot-up and response pattern[0] 407 may be set during runtime of the agent 441.

A response pattern matching component 419 identifies transactions carrying the agent 441 which match a response pattern from the response pattern storage 409. The response pattern matching component 419 works in a manner similar, if not identical, to the matching component 219. However, the generated match identifier does not send the identifier to the transaction tracker 241. Instead, the generated match identifier is sent to the trigger generation component 443.

The majority of entries of the transaction tracker 429 as shown in FIG. 4(a) are all valid. An entry marked in such a manner may be used to help generate a trigger for an external entity (such as a logic analyzer) to begin a task such as “watching” for a particular transaction and recording information associated with that transaction, start storing data, stop storing data, or selectively filtering data. Entry 445, however, is marked as invalid. This entry cannot generate a trigger. While the match, tag, and data entry components of 445 are not shown to have values in them in this example, these components may any value in them (for example, the match bits 421 may have all 0s or any other value, since either having match bits that are all 0 or valid bit that is 0 will keep a trigger from being generated by an entry).

The trigger generation component 443 compares a match from the matching component 419 to a value from transaction tracker entry. A response causes a trigger if a corresponding match bit or bits from the response match are set in the request match that is stored in the tracker entry with the same tag as the response, and the valid bit for that entry is set. For example, if the request match is 0110 from the tracker and the response match is 0010 a trigger may be generated (if the validity bit is set) because bit 1 is set in each match. In other words, match bits 421 do not have to be identical to what the match component 419 produces, only corresponding bit positions need to be set in both the request and response matches. However, if the request match or response match is 0000 a trigger will not be created as described above.

Generally, each outgoing response is compared to the response match pattern, and if it matches, the tracker entry is checked to see if it is marked as valid (and therefore valid to generate a trigger. If marked, a trigger signal is generated if any of the corresponding bit positions in the stored request match and the response match are both set. The entry will be marked invalid after it retires (whether or not a trigger is generated) and no future response will be able to match that response. If the entry is not marked as invalid, a subsequent response to a trigger may cause a false trigger to be generated. The trigger signal may be used to cause an internal action, pulse a pin to indicate the trigger occurrence, send an in-band debug message, or any other desirable response.

The trigger generation component 443 of FIG. 4(a) is illustrated as a collection of AND gates and an OR gate. As described above, triggers are generated for entries where the valid bit 427 is set. Each AND gate has one input connected to a single (bit) value from the tracker 429 and one input connected to single (bit) value from the matching component 419. The output of these AND gates is then ORed to possibly produce a trigger. The output of this OR gate is ANDed with the valid bit for the entry to determine if a trigger should be generated. If the validity bit is not set or there were no corresponding bits set between the response pattern 419 and the match bits 421 then a trigger is not generated. Other logic may be used such as using NAND/NOR gates, etc.

The portions shown in FIGS. 4 and 2 may be combined to form a single agent. Certain components will therefore be shared such as the tracker 429, 229. Additionally, the response pattern(s) 409 and request pattern(s) 209 and/or the matching logics 419, 219 may be the same, respectively, and combined to form single pattern storage and/or single match logic.

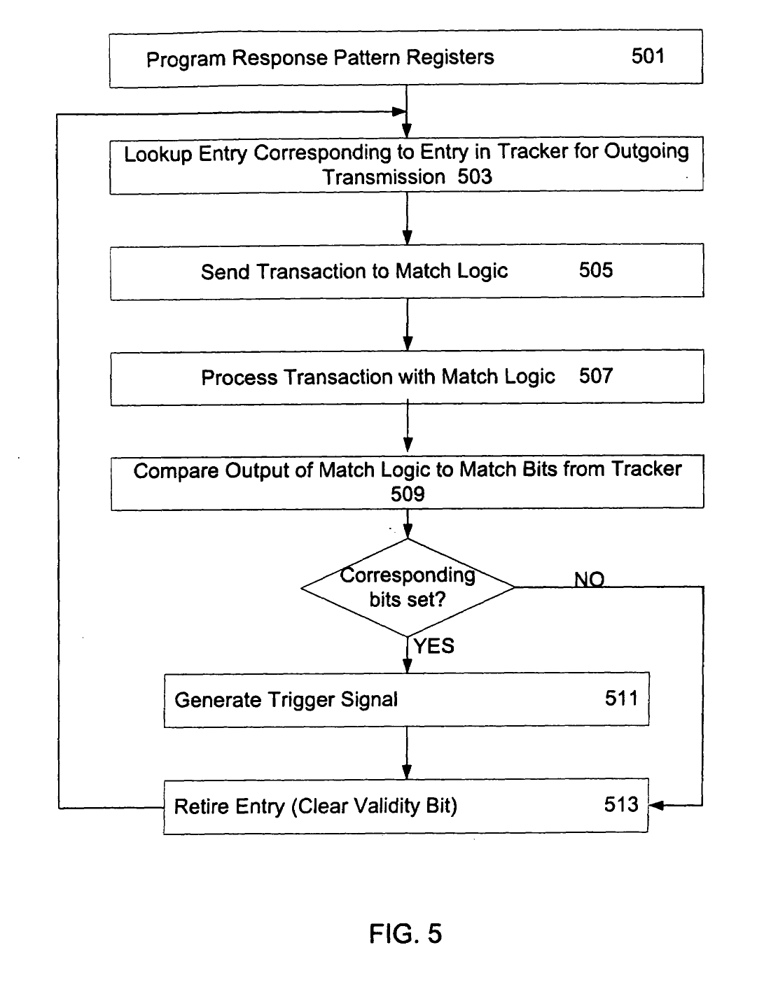

FIG. 5 illustrates an exemplary embodiment of a flow for generating a trigger in response to an outgoing response from an agent. At 501, at least a portion of the response pattern(s) of the agent are programmed. For example, a portion of the response pattern storage 409 is programmed. As described earlier, the programming of response patterns may occur prior to boot or during operation of the agent.

An outgoing transaction is generated by the agent and the corresponding entry is looked up by tag in the tracker at 503. For example, a transaction is received by the transaction tracker 429. In an embodiment, if no corresponding entry exists then no trigger will be generated.

The transaction is received by or sent to the matching logic at 505. The matching logic processes the transaction at 507 by comparing the transaction to the stored response patterns. Any matches between the transaction and response patterns are used to generate an indicator. For example, in FIG. 4(b) a match was found between response pattern[0] 407 and the outgoing transaction by response match[0] 417.

The indicator generated by the matching logic is compared to the identifiers stored in the entries of the tracker at 509. The trigger generating component performs this comparison and generates a trigger at 511 if a positive (match) is found and the entry is valid. For example, in FIG. 4(b), the match bits set in the positions of entry 433 and match bits generated by matching logic 419 are compared by the trigger generating component 443. In this example, the bit positions match. The validity bit is also taken into account. As illustrated, the validity bit was a “1” and a trigger is generated.

If a positive match is not found, and therefore there no value in the tracker matches the outgoing transaction, then the next transaction is processed. For example, entries 431 and 435 do not match the indicator “0001” and would therefore not generate a trigger. In an embodiment, if multiple request matches occur (as indicated by multiple bits being set in tracker match field 421), triggers are generated if any response match occurs.

The validity indicator in the tracker is cleared at 513 and the entry retired for a response that is returned regardless of whether or not it generates a trigger.

In a system with multiple agents, the above described components (pattern storage, matching logic, transaction tracker, and trigger generation) placed in agents provide a distributed triggering solution that can detect a specific response to a request anywhere in a system. For example, in a four processor system there may be a need to trigger on a dirty snoop response to a read from a specific address block. Each agent of the system would be programmed to look for an incoming snoop to that specific address block and for a dirty snoop response. Any agent of the system providing a dirty snoop response would detect it and signal the outside world by pulsing a pin or sending an in-band debug message. The pulsed pin or debug message trigger external observation agents (such as a logic analyzer) to store the bus traffic around the transaction of interest.

Embodiments of the invention may be implemented in a variety of electronic devices and logic circuits. Furthermore, devices or circuits that include embodiments of the invention may be included within a variety of computer systems, including a point-to-point (p2p) computer system and shared bus computer systems. Embodiments of the invention may also be included in other computer system topologies and architectures.

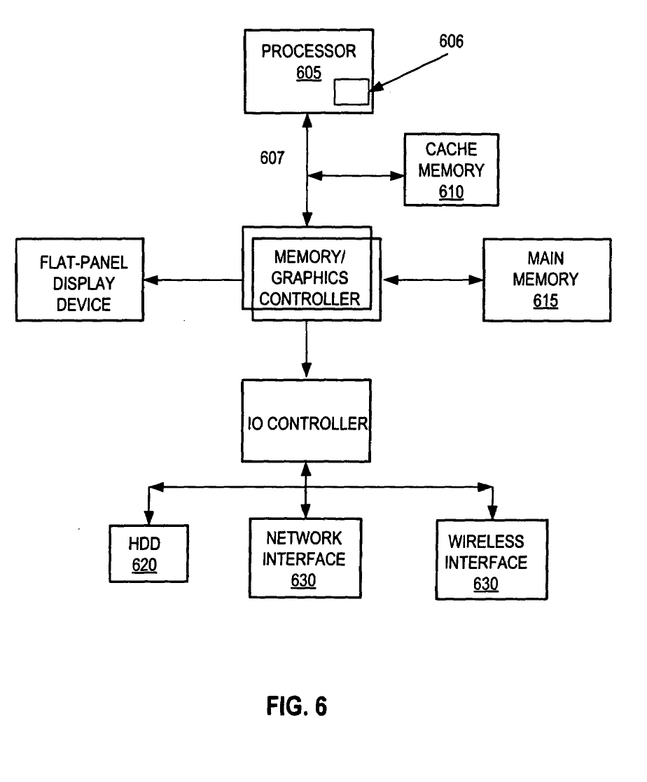

FIG. 6, for example, illustrates a front-side-bus (FSB) computer system in which one embodiment of the invention may be used. A processor 605 accesses data from a level one (L1) cache memory 610 and main memory 615. In other embodiments of the invention, the cache memory may be a level two (L2) cache or other memory within a computer system memory hierarchy. Furthermore, in some embodiments, the computer system of FIG. 6 may contain both a L1 cache and an L2 cache.

Illustrated within the processor of FIG. 6 is one embodiment of the invention 606. The processor may have any number of processing cores. Other embodiments of the invention, however, may be implemented within other devices within the system, such as a separate bus agent, or distributed throughout the system in hardware, software, or some combination thereof.

The main memory may be implemented in various memory sources, such as dynamic random-access memory (DRAM), a hard disk drive (HDD) 620, or a memory source located remotely from the computer system via network interface 630 containing various storage devices and technologies. The cache memory may be located either within the processor or in close proximity to the processor, such as on the processor's local bus 607.

Furthermore, the cache memory may contain relatively fast memory cells, such as a six-transistor (6T) cell, or other memory cell of approximately equal or faster access speed. The computer system of FIG. 6 may be a point-to-point (PtP) network of bus agents, such as microprocessors, that communicate via bus signals dedicated to each agent on the PtP network. Within, or at least associated with, each bus agent may be at least one embodiment of invention 606. Alternatively, an embodiment of the invention may be located or associated with only one of the bus agents of FIG. 6, or in fewer than all of the bus agents of FIG. 6.

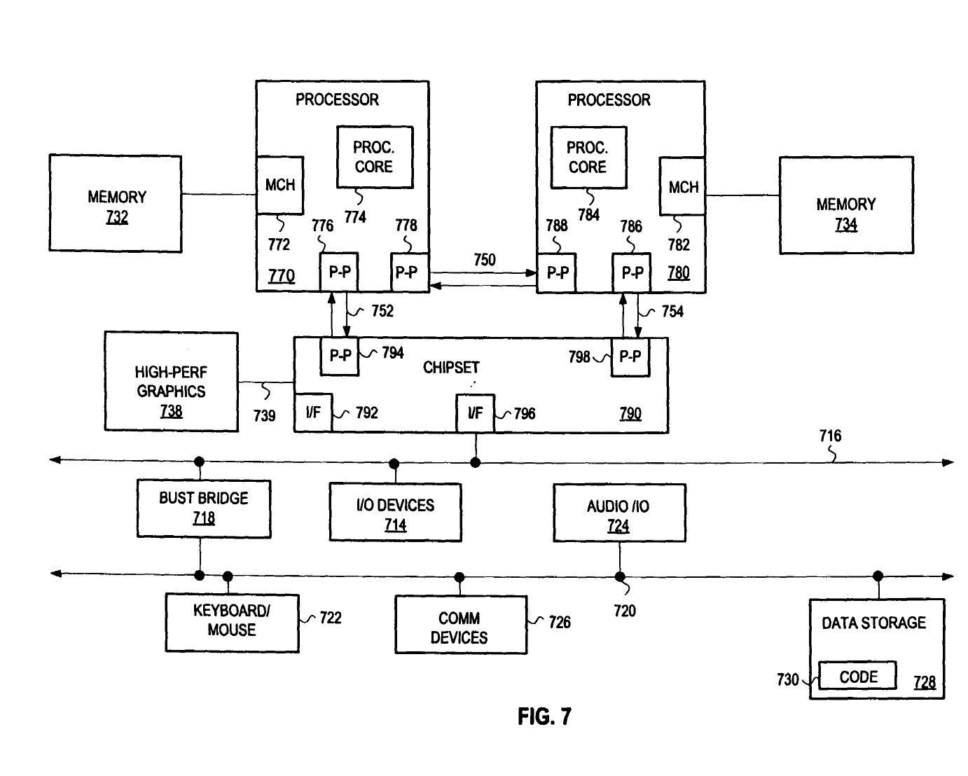

Similarly, at least one embodiment may be implemented within a point-to-point computer system. FIG. 7, for example, illustrates a computer system that is arranged in a point-to-point (PtP) configuration. In particular, FIG. 7 shows a system where processors, memory, and input/output devices are interconnected by a number of point-to-point interfaces.

The system of FIG. 7 may also include several processors, of which only two, processors 770, 780 are shown for clarity. Processors 770, 780 may each include a local memory controller hub (MCH) 772, 782 to connect with memory 732, 734. Processors 770, 780 may exchange data via a point-to-point (PtP) interface 750 using PtP interface circuits 778, 788. Processors 770, 780 may each exchange data with a chipset 790 via individual PtP interfaces 752, 754 using point to point interface circuits 776, 794, 786, 798. Chipset 790 may also exchange data with a high-performance graphics circuit 738 via a high-performance graphics interface 739. Embodiments of the invention may be located within any processor having any number of processing cores, within a chipset, or within each of the PtP bus agents of FIG. 7.

Other embodiments of the invention, however, may exist in other circuits, logic units, or devices within the system of FIG. 7. Furthermore, in other embodiments of the invention may be distributed throughout several circuits, logic units, or devices illustrated in FIG. 7.

Each device illustrated in FIGS. 6 and 7 may contain multiple cache agents, such as processor cores, that may access memory associated with other cache agents located within other devices within the computer system.

For the sake of illustration, an embodiment of the invention is discussed below that may be implemented in a p2p computer system, such as the one illustrated in FIG. 7. Accordingly, numerous details specific to the operation and implementation of the p2p computer system of FIG. 7 will be discussed in order to provide an adequate understanding of at least one embodiment of the invention. However, other embodiments of the invention may be used in other computer system architectures and topologies, such as the shared-bus system of FIG. 6. Therefore, reference to the p2p computer system of FIG. 7 should not be interpreted as the only computer system environment in which embodiments of the invention may be used. The principals discussed herein with regard to a specific embodiment or embodiments are broadly applicable to a variety of computer system and processing architectures and topologies.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.)), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

It is believed that processes taught by the discussion above may also be described in source level program code in various object-orientated or non-object-orientated computer programming languages (e.g., Java, C#, VB, Python, C, C++, J#, APL, Cobol, Fortran, Pascal, Perl, etc.) supported by various software development frameworks (e.g., Microsoft Corporation's .NET, Mono, Java, Oracle Corporation's Fusion, etc.). The source level program code may be converted into an intermediate form of program code (such as Java byte code, Microsoft Intermediate Language, etc.) that is understandable to an abstract execution environment (e.g., a Java Virtual Machine, a Common Language Runtime, a high-level language virtual machine, an interpreter, etc.), or a more specific form of program code that is targeted for a specific processor.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

I claim:

1. A method, comprising:
determining if an incoming transaction matches a request pattern;
determining if an outgoing transaction matches a response pattern;
determining if the outgoing transaction matches the response and incoming transaction matches the request pattern; and
generating a trigger signal if the outgoing transaction matches the response and the incoming transaction matches request pattern.

2. The method of claim 1, wherein the response and request patterns include a portion of a header.

3. The method of claim 1, further comprising:
receiving an incoming transaction;
comparing the incoming transaction to a request pattern; and
generating a transaction tracker entry for the incoming transaction, the transaction tracker entry including:
a transaction identification, and
a request pattern match identifier.

4. The method of claim 3, wherein determining if the outgoing transaction matches the response and incoming transaction matches the request pattern further comprises:
comparing the request pattern match identifier of the transaction tracker entry for the incoming transaction to a response pattern match identifier of the outgoing transaction.

5. The method of claim 3, wherein the transaction tracker entry further includes:
data from the incoming transaction; and
a validity bit.

6. The method of claim 4, wherein the transaction entry is an entry in a table.

7. The method of claim 1, further comprising:
programming the request pattern.

8. A system comprising:
a transaction tracker to track a transaction processed by an agent;
pattern matching logic to compare the transaction to a pattern; and
pattern storage to store the pattern to be compared.

9. The system of claim 8, further comprising;
trigger generation circuitry, the trigger generation circuitry to generate a trigger for an outgoing transaction that matches a request pattern and response pattern.

10. The system of claim 8, wherein the pattern matching logic further comprises:
a set of one or more first pattern matching components to compare a set of one or more request pattern values to an incoming transaction; and
a set of one or more second pattern matching components to compare a set of one or more response pattern values to an outgoing transaction.

11. The system of claim 10, wherein the pattern matching logic is a set of one or more masks.

12. The system of claim 8, wherein the pattern storage comprises a set of one or more registers.

13. The system of claim 8, wherein the transaction tracker stores one or more entries corresponding to one or more transactions.

14. The system of claim 8, wherein an entry in the transaction tracker comprises:
a transaction identification; and
a request pattern match identifier.

15. An article of manufacture including program code which, when executed by a machine, causes the machine to perform a method, the method comprising:
determining if an incoming transaction matches a request pattern;
determining if an outgoing transaction matches a response pattern;
determining if the outgoing transaction matches the response and incoming transaction matches the request pattern; and
generating a trigger signal if the outgoing transaction matches the response and the incoming transaction matches request pattern.

16. The article of manufacture of claim 16, wherein the response and request patterns includes a portion of a header.

17. The article of manufacture of claim 16, further comprising:
receiving an incoming transaction;
comparing the incoming transaction to a request pattern; and
generating a transaction tracker entry for the incoming transaction, the transaction tracker entry including:
a transaction identification, and
a request pattern match identifier.

18. The article of manufacture of claim 17, wherein determining if the outgoing transaction matches the response and incoming transaction matches the request pattern further comprises:
comparing the request pattern match identifier of the transaction tracker entry for the incoming transaction to a response pattern match identifier of the outgoing transaction

19. The article of manufacture of claim 18, wherein the transaction tracker entry further includes
data from the incoming transaction.

20. The article of manufacture of claim 18, wherein the transaction entry is an entry in a table.
